(19) United States
(12) Patent Application Publication
(10) Pub. No.: US 2017/0132864 A1
(43) Pub. Date: May 11, 2017

(54) METHOD AND A SYSTEM FOR CONTROLLING THE OPENING OF DOORS GIVING ACCESS TO VARIOUS REGULATED-ACCESS ZONES OF A SECURE PERIMETER

(71) Applicant: ANTALIOS, MARSEILLE (FR)

(72) Inventors: Patrick ADAM, LA CIOTAT (FR); Christophe PISTORESI, LES PENNES MIRABEAU (FR)

(21) Appl. No.: 15/346,814

(22) Filed: Nov. 9, 2016

(30) Foreign Application Priority Data
Nov. 10, 2015 (FR) 15 60746

(51) Int. Cl. G07C 9/00

(52) U.S. Cl. CPC G07C 9/00309; G07C 2009/00769

(57) ABSTRACT

The disclosure relates to a method and a system for controlling the opening of doors (D1-D6) giving access to various regulated-access zones (P1-P6) in a secure perimeter, the method comprising using readers (4a, 4b) specific to each door of the secure perimeter to obtain an identifier of a person seeking to open a door of the secure perimeter in order to access to a regulated-access zone; obtaining at least one item of context information relating to the environment of the regulated-access zone into which the person seeks access; and determining an access decision by means of a control entity (6) specific to the regulated-access zone into which the person is seeking access, said access decision being established on the basis of the person's identifier and of the context information.

### BACKGROUND

The present disclosure relates to the general field of controlling the opening of doors giving access to various regulated-access zones of a secure perimeter.

The need to control access has increased considerably in our society. The problem of insecurity in various sectors, and also the computer means used for combating this trend, are becoming ever more present. In particular, numerous organizations (governmental or business) work on dossiers of a confidential nature, which requires them to install a system for controlling access to such dossiers. Likewise, most work places, such as business offices, warehouses, and retail shops need to secure their premises in order to prevent theft of intangible property and/or goods, and in order to protect their employees. As a result, such organizations have increasing needs for traceability concerning both objects and people.

Systems known in the prior art for controlling access to the insides of rooms of a secure perimeter are generally based on the people moving within the secure perimeter while wearing badges, with it being necessary for each person to be identified at the entry door to each room in order to obtain (or not obtain) access authorization. Such systems present limits in the centralized manner in which they take their access decisions (whether to allow a person to pass from one room to another), and also in the level of access security, which generally relies on the sole criterion of the person's identifier (coming from the badge worn by the person).

In general, during the control process, such systems make use of a remote database, giving rise to drawbacks in terms of response times to an access request and of system vulnerability in the event of malicious attacks in situations of degraded operation. A decision concerning access is thus taken in centralized manner and is typically performed by a central computer in which the data is stored. Furthermore, such decision-taking is limited since it is based on only a few criteria, such as a time of day and a person's access authorizations, and it is not flexible (i.e. cannot adapt to different security situations).

In addition, such systems generally do not track objects, such that the decision is taken without taking account of potential incompatibility between objects and people being in the same room (by way of example, a document classified as secret being present in a room into which a person not entitled to read such a document is seeking access).

### OBJECT AND SUMMARY OF THE DISCLOSURE

An object of the present disclosure is thus to provide a method and a system for controlling access that do not present the above-mentioned drawbacks.

In accordance with the disclosure, this object is achieved by a method of controlling the opening of doors giving access to various regulated-access zones in a secure perimeter, the method comprising:
using readers specific to each door of the secure perimeter to obtain an identifier of a person seeking to open a door of the secure perimeter in order to access to a regulated-access zone;
obtaining at least one item of context information relating to the environment of the regulated-access zone into which the person seeks access; and
determining an access decision by means of a control entity specific to the regulated-access zone into which the person is seeking access, said access decision being established on the basis both of the person's identifier and also of the context information.

The term “secure perimeter” is used herein to mean any building having rooms that are partitioned from one another by doors, such as business premises, warehouses, shops, factories, prisons, etc.

The method is remarkable in that the access decision (to open or not to open the door) is based not only on the identifier of the person seeking access to a regulated-access zone of the secure perimeter, but also on the basis of context information relating to the environment of the regulated-access zone. The access decision can thus be based on multiple criteria other than merely the person's identifier and the time of day.

The method is also remarkable in that the access decision is taken by respective control entities that are specific to each regulated-access zone of the secure perimeter. Thus, decision-taking is decentralized (it takes place locally near the door) with all of the advantages that that procures. In particular, it is possible to avoid any risk of the system being vulnerable to malicious attacks or to situations of degraded operation.

More generally, the method of the disclosure makes it possible to monitor intelligently the movements of people and of objects within the secure perimeter. In other words, by the method of the disclosure, each person and each object moving within the secure perimeter is being monitored continuously by the control entities and is interacting with the readers installed at each door (one reader on each side of any given door). These control entities serve to supervise and validate movements of a person or of an object carried by that person within regulated-access zones of the secure perimeter. In particular, the control entities can handle potential incompatibilities that might exist between people and objects.

In a particularly advantageous manner, the control entities of the various regulated-access zones in the secure perimeter communicate with one another. Thus, all these control entities receive the same data (in particular the people and objects accessing the various regulated-access zones), which enables them to operate completely independently without passing via a data storage center. The dynamic data relating to the content of the regulated-access zones is updated in real time and is exchanged between the various control entities of the secure perimeter.

Decentralizing the taking of access decisions serves to improve data security and to improve the performance of the control system by avoiding storing all of the data within a single entity. Decentralization also makes it possible to obtain an access decision more quickly than would be possible if the decision were taken by a central control unit (the amount of data transferred is smaller).

The context information may be selected from the following information: authorization to access at a determined instant; mode of operation of the regulated-access zone; mode of operation of the door; and presence of elements conflicting with the regulated-access zone.

Also advantageously, the control entity determines the access decision on the basis of a holonic and isoarchical model. With such a model, all of the control entities concerned by the access decision that is to be taken are at the same decision-taking level and they all contribute to determining the access decision.

Under such circumstances, the holonic and isoarchical model may be constructed from material structures (referred to as M_Holons”) and information structures (referred to as I_Holons”) each of which is associated with the following entities: entities relating to the people to be checked; entities relating to the objects to be checked; entities relating to the doors to be controlled; and entities relating to missions.

Each entity relating to a person to be checked may be constituted by a material structure containing the person proper, and by an information structure containing the identifier of the person, and data relating to tracing movements of the person within the secure perimeter.

Likewise, each entity relating to an object to be checked may be constituted by a material structure containing the object proper, and by an information structure containing an identifier of the object, and data relating to the position of the object within the secure perimeter.

The entity relating to a door to be controlled may be constituted by a material structure containing the door proper, and by an information structure containing data relating to the mode of opening the door.

Finally, each entity relating to a mission may be constituted by a material structure containing one or more regulated-access zones of the secure perimeter, and by an information structure containing access authorizations to said regulated-access zones or a movement order in the secure perimeter.

As mentioned above, the holonic and isoarchical model from which the access decision is determined may be based on an analytic hierarchy process.

The disclosure also provides a system for controlling the opening of doors giving access to various regulated-access zones of a secure perimeter, the system comprising:
means for reading an identifier of a person and associated with each door of the secure perimeter;
means for obtaining at least one item of context information relating to the environment of each regulated-access zone of the secure perimeter; and
control entities specific to each regulated-access zone of the secure perimeter, each of said control entities being suitable for taking an access decision on the basis both of an identifier of a person seeking to open a door of the secure perimeter in order to access a regulated-access zone and also of context information relating to the environment of the regulated-access zone that the person is seeking to access.

In this system, each control entity of the various regulated-access zones of the secure perimeter may be connected to each of the others in order to exchange data. Furthermore, the means for reading an identifier of a person may comprise a badge reader operating by radio identification.

### BRIEF DESCRIPTION OF THE DRAWINGS

Other characteristics and advantages of the present disclosure appear from the following description made with reference to the accompanying drawings, which show an implementation having no limiting character. In the figures:

FIG. 1 is a diagram of a secure perimeter fitted with a door-opening control system of the disclosure;

FIG. 2 is a diagram showing the control principle of the disclosure;

FIG. 3 shows an example decision structure prepared on the basis of an analytic hierarchy process for performing a control method of the disclosure; and

FIG. 4 is a flow chart showing an example of the process for checking a person in accordance with the disclosure in a detention center.

### DETAILED DESCRIPTION

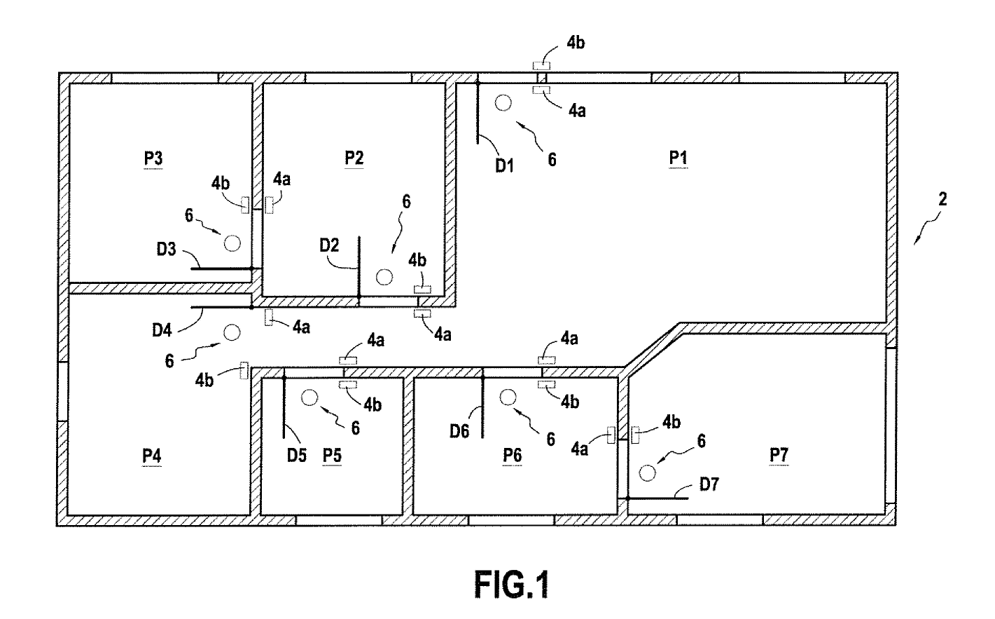

FIG. 1 is a diagram of a building 2 forming a secure perimeter fitted with a door-opening control system of the disclosure.

The building 2 may be premises in a business, a warehouse, a shop, a factory, a prison, etc., or any other perimeter having a plurality of rooms partitioned off from one another by doors. In this example, the building 2 has seven rooms P1 to P7 that are partitioned from one another by as many doors D1 to D7.

In its hardware architecture, the control system of the disclosure comprises specifically for each door D1 to D7 of the building: two badge readers 4a and 4b operating by radio frequency identification (RFID), the two badge readers 4a and 4b being situated on opposite sides of the door. Naturally, the RFID batch readers could be replaced by any other device for reading registration and/or biometric data for identifying a person.

The control system of the disclosure also has control entities 6 that are associated with each of the regulated-access zones in the building (i.e. each of the rooms P1 to P7).

The control entity 6 of a door comprises a microcomputer having a memory and software that is configured to process data in order to take an access decision on the basis of an algorithm that is described below. The data comes from the two badge readers 4a and 4b relating to the corresponding door, and also from the other control entities of the building. For this purpose, the control entities 6 of the building are connected to one another to exchange data (e.g. by means of a communications network of wired type, of WiFi type, etc., for example, a secure network).

Thus, data about people and objects as picked up by the badge readers 4a, 4b of a door is transmitted to the control entity 6 of the corresponding room and also to all of the other control entities, without passing via a storage center.

The control system may also include other sensors (for sensing temperature, pressure, etc.) and/or other detectors (for detecting smoke, fire, radioactivity, etc.) that are positioned in some or all of the rooms P1 to P7 of the building, which sensors and/or detectors are connected to the corresponding control entity. As for the data picked up by the badge readers, the data picked up by the sensors and/or detectors is transmitted in real time to all of the control entities of the building.

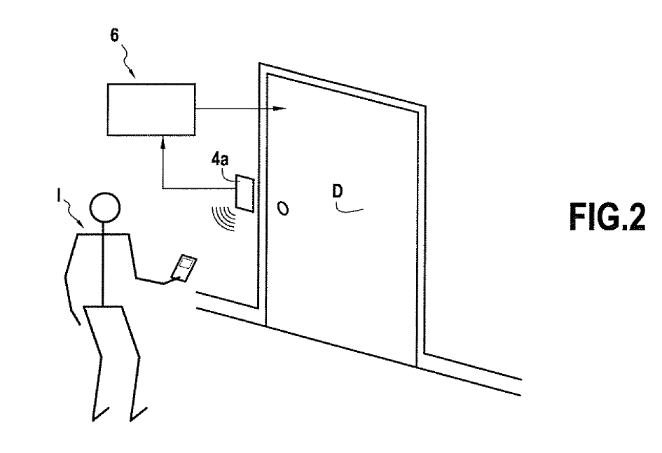

FIG. 2 is a diagram showing the principle (the main steps) of the control method of the disclosure using the system of FIG. 1.

A person I coming up to a (closed) door D of the building in order to go through the door must be identified by means of that person's RFID badge (using the corresponding badge reader 4a of the door). The data transmitted by the badge reader (i.e. the identifier of the person I, e.g. in the form of registration data and/or biometric data) is synchronized with registration data stored in a memory of the corresponding control entity 6.

The control entity then analyses the person's request by applying a model based on a multi-criterion hierarchical architecture (described in detail below). This model for making the access decision takes account not only of the identifier of the person I together with any data picked up by the sensors and/or detectors present in the room, but also of any context information relating to the environment of the room to which the person is seeking access.

Contact information relating to the environment of the room may be of multiple and varied kinds. By way of non-limiting example, mention may be made of: access being authorization at a determined time; a mode of operation of the room; a mode of operation of the door; the presence of absence of conflicting elements (people or objects) in the room; etc.

The access decision that is determined by this analysis with multiple criteria performed by the control entity 6 in question is manifested by the door being opened (e.g. by its lock being unlocked) or by the door being kept in the closed position, possibly in combination with a call to a supervisor.

Furthermore, data concerning badge-carrying people and objects at the door D is duplicated in real time on all of the control entities of the building. The same applies to the context information relating to the environment of the room. This data decentralization enables each control entity to benefit from the same information and thus to be capable of taking an access decision in independent manner with minimized response time. The accessible data is available in particular even in the event of operation being degraded (e.g. a failure of the communications network).

Not only is data decentralized, control within a control entity is also decentralized. In particular, all hierarchical subordination links are abandoned in favor of heterarchical (or isoarchical) links. In the control system and method of the disclosure, decentralization is characterized by a functional architecture based on duplicating identical decision-taking mechanisms over all of the control entities of the control system. The functions of managing access requests are produced identically on all of the control entities, which have been subjected to settings that enable the decision-taking mechanisms to be adapted to their own characteristics in order to obtain different behaviors.

In order to ensure the decentralized nature of decision taking and in order to eliminate any hierarchy in the decision-taking structure, the control method of the disclosure makes use of a model that is holonic and isoarchical.

The term “isoarchical” is used to mean that all of the control entities of the control system of the disclosure are given the same decision-taking power. Thus, at a given decision-taking level, the various control entities have exactly the same authority (both in terms of function and in terms of time). In this isoarchical decision-taking architecture, all of the control entities concerned by a decision that is to be taken are at the same decision-taking level and they all contribute to taking the decision.

The holonic model is well adapted to control entities for which decision-taking is decentralized. In general manner, in such a model, a basic element known as a “holon” is defined, which is constituted by a conceptual entity relying on an association of a material structure (referred to as the “M_Holon”) and an information structure (referred to as the “I_Holon”) enabling the holon to take a decision in independent manner and to interact with other holons.

In the disclosure, the material structures (M_Holon) and information structures (I_Holon) are each associated with the following entities: entities relating to the people to be checked (referred to as “Individual Holons”); entities relating to objects to be checked (referred to as “Object Holons”); entities relating to doors to be controlled (referred to as “Door Holons”); and entities relating to missions (referred to as “Mission Holons”).

More precisely, each entity relating to a person to be checked (“Individual Holons”) is constituted by a material structure (Individual_M_Holon) containing the person proper, and an information structure (Individual_I_Holon) containing the identifier of the person (e.g. registration data and/or biometric data of that person) together with data relating to traceability of movements of the person within the building.

In the presently-described example, it is the RFID technology of the badge readers that enables each Individual_M_Holon of a person to be associated with that person's Individual_I_Holon. The identifier of the badge of each Individual_M_Holon is scanned on arrival at the door, thus making it possible to synchronize the Individual_M_Holon with the Individual_I_Holon and determine the identifier of the moving person.

This identification also makes it possible to maintain traceability of the movements of the person within the building. For this purpose, when an access decision is given to the person (by opening the door), the change of state of the entity relating to the person for checking and the entity relating to that person's mission (above-mentioned “Mission Holon”) can be implemented. Likewise, the presence of Individual_M_Holon in the new room is transmitted to all of the entities associated with the doors of the room (above-described “Door Holons”) and the entities associated with the doors of the room that has been left are also informed of this change of state.

Each entity relating to an object for checking (“Object Holons”) is constituted by a material structure (Object_M_Holon) containing the object proper, and an information structure (Object_I_Holon) containing an identifier of the object and data relating to the position of the object within the building.

In the same manner as for the “Individual Holons”, RFID technology enables each Object_M_Holon of an object to be associated with its Object_I_Holon. More precisely, the identifier of an object (Object_M_Holon) is scanned on entering into a room (by detection using a badge detector placed in the room), thus making it possible to synchronize the Object_M_Holon with the Object_I_Holon and to discover the identifier of the object entering the room. The presence of the “Object Holon” in the new room and its departure from the old room are transmitted to all of the “Door Holons” of the room and to all of the “Door Holons” of the room that has just been left.

Each entity relating to a door that is to be controlled (“Door Holons” belonging to one or two rooms) is constituted by a material structure (Door_M_Holon) containing the door proper, and an information structure (Door_I_Holon) containing data relating to the door-opening mode, i.e. the technology for opening the door (electric lock, door that opens under motor control, etc.).

The information structure (Door_I_Holon) may also contain data about opening times of the door, its mode of operation (nominal, or specific to a specific situation), its emergency mode (alarm, fire, riot—in particular for a prison), etc.

Each entity relating to a mission (“Mission Holons”) is constituted by a material structure (Mission_M_Holon) containing one or more rooms of the building, and an information structure (Mission_I_Holon) containing access authorizations for said rooms or an order for movement in the building.

More precisely, the “Mission Holons” relating to an Individual Holon or a group of Individual Holons may be of two types: a “Zone Holon” containing access authorizations to a specific location in the building; or else a “Path Holon” that contains permission to go from one specific location to another in the building, specifying the doors to go through. This latter type of Holon may be temporary (e.g. a one-off authorization given by a warder to a prisoner to go to a visitors' room, to an infirmary, etc.) or it may be repetitive (authorization to go to a workplace at a specific time every day or once a week).

In the method of the disclosure, people movement orders are defined directly in the access control system so that the material structure (Mission_M_Holon) is synchronized with the information structure (Mission_I_Holon).

On the basis of the data (relating to people and to objects as picked up at the doors of the building and context information relating to the environment of the rooms of said building) that is duplicated in real time on all of the control entities, the method of the disclosure uses software in each control entity to perform multi-criterion hierarchical analysis serving to take an access decision (open or not open the door in question, possibly also calling a supervisor).

In this example, this multi-criterion analysis takes account of all of the criteria that may be involved in taking an access decision and serves to classify various actions following on from a person requesting access authorization.

For this purpose, the analysis may make use of an analytic hierarchy process (AHP). Such a process, which is known to the person skilled in the art and is therefore not described in detail herein, serves to define the decision-taking problem in the form of a hierarchy structure in order to provide assistance in coping with complex decisions.

Briefly, an analytic hierarchy process involves a “static” stage of configuring the algorithm in which the settings for the relative importance of the criteria and of their indicators are adjusted, and a “dynamic” stage in which the algorithm is used and alternatives are classified relative to the overall goal.

The “static” stage of configuration consists initially in inputting the decision-taking problem as posed and representing it by a hierarchical structure of levels reflecting the interactions between the elements of the problem. The problem is broken down into levels starting from the following guidelines: identifying general goals (level 1), identifying criteria (level 2), and identifying indicators below each criterion (level 3).

The step following the configuration stage consists in classifying the criteria (level 2) relative to the overall goal (level 1). For this purpose, a matrix [CC] of rank nc is constructed in which each element (i,j) is a judgment or a comparison between a pair of criteria Crᵢ, Crⱼ. The value of the comparison CC[i,j] is a value on a scale of 1 to 9 in which the value “1” defines importance that is equivalent (i.e. there is no preference), and the value “9” defines an absolute preference, such that:

CC[j,i]=1/CC[i,j]

and

CC[i,j]=1

In other words, the diagonal of the matrix is constituted by “1s” and the bottom portion is the reciprocal of the top portion.

This matrix [CC] makes it possible to determine the priority vector [CrOg], which is given by the following formula:

CrOg=CC*e^{T}/e*CC*e^{T}

where e=1, 1, . . . , 1.

The last vector to be obtained corresponds to the relative importance vector that is used. This vector expresses the relative importance of the criteria (level 2) with respect to the overall goal (level 1).

The following step of the configuration stage consists in classifying the indicators (level 3) relative to the criteria (level 2). For all of the criteria of level 2, each of these indicators is classified relative to its corresponding criterion. For this purpose, a square matrix [Indₖ] of rank nₖ is constructed in which each element (i,j) is a judgment or a comparison between a pair of indicators I_{k,i} and I_{k,j}, where nₖ is the number of indicators of the criterion k. For each matrix [Indₖ] the priority vector [ICrₖ] is estimated. The vector that is retained expresses the relative importance of the indicators (level 3) with respect to each of the criteria (level 2). During this step, the coherence ratio C.R is also calculated in order to verify the coherence of the comparisons.

The “dynamic” stage of implementing the algorithm as configured in this way serves to classify the alternatives relative to the overall goal.

Initially, this stage consists in classifying the alternatives (level 4) relative to the indicators (level 3) of each criterion. For each indicator I_{k,j} of level 3 belonging to the set Iₖ, the values I_{k,l} are compared between the alternatives Aᵢ of the set of alternatives under consideration so as to construct matrices [Ak,l] with:

A_{k,l}(i,j)=I_{k,l}(j)/I_{k,l}(i)

in order to minimize the criterion so as to conserve the same scale signification used in the algorithm.

Thereafter, the relative importance of the alternatives (level 4) is classified with respect to the criteria (level 2) by traversing the tree structure upwards and by comparing the set of alternatives with respect to all of the criteria. A vector giving the relative importance of the alternatives with respect to the criteria is constructed, with this being done for each of the criteria:

[ACrₖ]=[AIndₖ]*[ICrₖ]

The vectors [ACrₖ] serve to construct a matrix [ACr] as follows:

[ACr]=[ACr₁, ACr₂, . . . , ACr_{nc}]

with nc being the number of criteria.

Finally, the following step consists in classifying the relative importance of the alternatives (level 4) with respect to the overall goal (level 1). For this purpose, the previously-determined priority vector [CrOg] and the classification performed in the preceding step enable the final solutions to be classified, with this being obtained as the product:

[ACr]*[CrOg]=[AOg]

giving the priority vector for the alternatives under consideration, i.e. the relative importances of these alternatives with respect to the overall goal (Og). The best alternative is selected from the priority vector [Perf], which classifies the values of the vector [Perf] in decreasing order. The best solution is then the greatest element in [Perf].

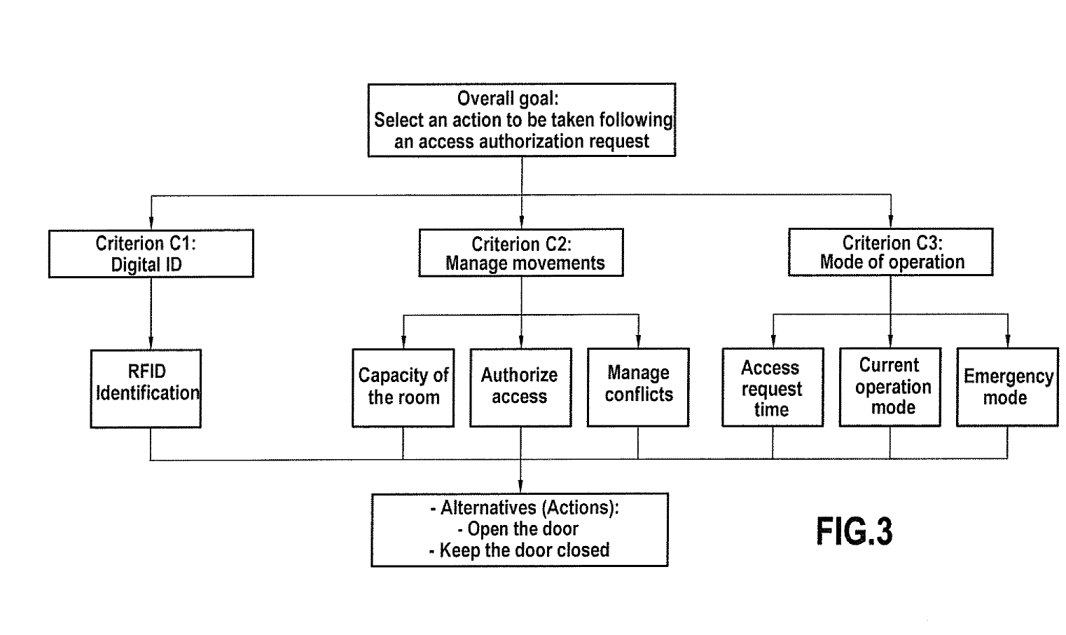

FIG. 3 shows such an analytic hierarchy process being applied to managing access authorizations of prisoners to various rooms in a detention center (secure perimeter) by specifying the various actions that can be taken as a result of a prisoner making a request for access authorization.

Three important criteria (level 2) are involved in taking a decision in this example: the digital identity (C1); managing the movement of people (C2); and the mode of operation of the regulated access zone (C3).

The digital identity is a criterion that consists in digitally verifying the person for checking. This criterion is represented by a single indicator which is the person's identifier. This identification is the result of verifying registration and/or biometric data and of that data matching the data of the RFID reader badge.

Managing the movements of people is a criterion that serves to take account of the way access authorizations are managed internally (movement orders), to take account of incompatibilities between people and/or groups and/or objects, and to take account of the states of the rooms at instant t. This criterion is represented by three indicators:

i) The capacity of the room: this indicator serves to limit access to a room when its maximum accommodation capacity has been reached. To calculate this indicator, two items of information are needed, namely the number of people present in the room at an instant t (which number is continuously updated by the messages exchanged between the control entity of the building), and the maximum capacity of the room, which is defined and stored in the control entity of the room.

ii) Managing conflicts: this indicator serves to limit access to a room when it contains one or more people and/or objects that are not compatible with the person in front of the door giving access to the room and requesting authorization to enter.

iii) Access authorization: this consists in verifying in the “Mission Holon” list whether the door forms part of a path or a zone through which the person is free to move.

The mode of operation of the regulated access zone is a criterion that represents the mode of operation of the zone relating to door-opening times, ordinary operating mode, and emergency mode. It is represented by three indicators:

i) Access request time: time constraints may be specified for the door (“Door Holons”) and also for access authorization (“Mission Holons”). Particularly, each “Door Holon” contains information about opening times for the door that it represents, and each “Mission Holon” may be associated with a time constraint that defines the validity of the authorization. Several situations can be distinguished: the time does not lie within the specified time ranges; the time lies within the Door Holon time range but outside the Mission Holon time range; the time lies in the Mission Holon time range, but outside the Door Holon time range; and the time lies within both the Door Holon and the Mission Holon time ranges.

ii) Current operation mode: this indicator serves to indicate the mode of operation in use in the zone. In this example, this indicator may be of three types: nominal (i.e. no particular recommendations); riot (particular recommendations may be issued favoring or on the contrary not favoring opening of the door); and escape (particular recommendations may be issued favoring or not favoring opening of the door). In nominal operation, this current operation mode should be the same for all of the control entities. Nevertheless, it is possible to envisage situations of degraded operation in which certain sectors of the zone are not operating like the others.

iii) Emergency mode: this indicator serves to take an emergency situation into account, concerning fire or evacuating the zone under control. This indicator may be of two types: nominal (no particular recommendation); fire or evacuation (recommendation to open the door while activating surveillance cameras).

The control system of the disclosure has been implemented for controlling access by prisoners and for tracking their personal objects in a detention center. That implementation is made up of two types of software module: an Observer module and control entity modules. The Observer module serves to configure the control system and to act in real time to observe the activity of each door in the detention center, while the control entity modules are deployed at each door in the detention center and manage access authorization requests. Each control entity module is permanently connected to two RFID type badge readers (one reader on each side of the door) in order to detect the identifier of a person coming up to the door and in order to synchronize that person's Individual_M_Holon and Individual_I_Holon. The Observer module and the control entity modules communicate with one another via an IP network.

The main actors in the system for controlling the movements of people in this particular application may be distinguished on the basis of their functions and of their needs. The following actors can be identified:
A prisoner: this is a person whose movements are to be controlled, which movements are to take place within the closed and secured zone. In order to access a room, a prisoner must go up to the door giving access and must have an RFID badge in order to be detected.
The configurer: this is the person who has control over all of the functions of the Observer module. Specifically, the configurer module is authorized to act in real time to track the activity of each door, and also to configure the system by means of the Observer station (remote configuration of the control entities, configuration of the rooms, configuration of individuals, etc.).
RFID readers: these are elements responsible for reading data stored in an RFID badge of a person requesting access and for transmitting that data to the control entities. These actors can also be involved at Observer module level when creating an RFID badge.

More precisely, the Observer module enables communication with the control entities to be managed by means of initialization messages and by means of the states of each control entity, and it also serves to configure the system. These functions can thus be broken down into two classes:
Functions relating to communication with the control entities, and to observing everything that happens in the control entities in real time. Specifically, each control entity is required to send to the observer the result of each access authorization request that is made, which result is then displayed and stored.
Functions relating to configuring the control system: these configuration operations relate to the control entities, the rooms in the prison, the people moving in the prison (prisoners or wardens—supervisor or configurer), the objects of individuals, groups of individuals, conflicts that may exist between prisoners, and movement orders. These configurations need all of the control entities to be updated. Any control entities that are not connected at the time of a change of configuration will be updated when they are next connected, providing the Observer is connected. Only the Observer can update the configuration in the control entities.

The RFID reader actor is involved in managing individuals and managing objects. Specifically, it serves to give RFID badges to individuals and to objects.

The table given below serves to show the various types of action relating to managing individuals.

“Management of individuals” Table

| | Actor(s) | |
|---|---|---|
| Action | involved | Description |
| Add | Configurer | Serves to add an individual to |
| individual | | the system. The fields for |
| | | filling in are: identifier (it |
| | | must be unique), type, surname, |
| | | forename, address, etc. On |
| | | being confirmed, an individual |
| | | entry is added to the |
| | | configuration file. |
| Create RFID | Configurer | Serves to associate an RFID |
| badge | RFID reader | badge with an individual. An |
| | | RFID reader is essential in |
| | | order to extract the identifier |
| | | from the badge. The |
| | | “individual” entry must exist |
| | | in the system in order to be |
| | | associated with a badge. This |
| | | association is stored in the |
| | | configuration file. |
| Edit | Configurer | Enables the data of a |
| individual | | particular individual to be |
| | | edited. All of the data can be |
| | | modified except for the |
| | | identifier. Modification |
| | | involves updating the |
| | | configuration file, and also |
| | | the Individual_Holon (if |
| | | present on the network). |
| Delete | Configurer | Serves to delete an individual |
| individual | | from the system. Deleting an |
| | | individual involves deleting |
| | | that person's data from the |
| | | configuration file and deleting |
| | | the Individual_Holon from the |
| | | network (all of the control |
| | | entities). Deletion |
| | | automatically removes the |
| | | individual from all of the |
| | | control entities. |
| Launch | Configurer | Serves to launch an |
| individual | | Individual_Holon in a selected |
| | | room. For the system to be |
| | | coherent, the configurer must |
| | | ensure that the corresponding |
| | | individual is physically |
| | | present in the room in |
| | | question. |
| Remove | Configurer | Serves to remove an |
| individual | | Individual_Holon from the |
| | | network. It is necessary to |
| | | ensure that the individual is |
| | | no longer in the zone since |
| | | otherwise the individual's |
| | | access requests will be |
| | | rejected and the individual |
| | | will be blocked. |

The table below serves to visualize various types of action relating to managing objects.

“Management of objects” Table

| | Actor(s) | |
|---|---|---|
| Action | involved | Description |
| Add object | Configurer | Serves to add an object to the |
| | | system. The fields for filling |
| | | in are: identifier (it must be |
| | | unique), type, name, and person |
| | | responsible for the object. On |
| | | being confirmed, an object |
| | | entry is added to the |
| | | configuration file. |
| Create RFID | Configurer | Enables an RFID badge to be |
| badge | RFID reader | associated with an object (in |
| | | similar manner to the table |
| | | above). |
| Edit object | Configurer | Enables the data of a |
| | | particular object to be edited. |
| | | All of the data can be modified |
| | | except for the identifier. |
| | | Modification involves updating |
| | | the configuration file, and |
| | | also the Object_Holon (if |
| | | present on the network). |
| Delete | Configurer | Serves to delete an object from |
| object | | the system. Deleting an object |
| | | involves deleting that object's |
| | | data from the configuration |
| | | file and deleting the |
| | | Object_Holon from the network |
| | | (all of the control entities). |
| | | Deletion automatically removes |
| | | the object from all of the |
| | | control entities. |
| Launch | Configurer | Serves to launch an |
| object | | Object_Holon in a selected |
| | | room. For the system to be |
| | | coherent, the configurer must |
| | | ensure that the corresponding |
| | | object is physically present in |
| | | the room in question. |
| Remove | Configurer | Enables an Object_Holon to be |
| object | | removed from the network. It |
| | | must be ensured that the object |
| | | is no longer in the secure |
| | | zone. |

The table below serves to visualize the various types of action relating to managing orders.

“Management of orders” Table

| | Actor(s) | |
|---|---|---|
| Action | involved | Description |
| Add order | Configurer | Enables an access authorization |
| | | to be added by creating movement |
| | | orders (Mission_Holon). Two |
| | | types of movement order may be |
| | | created: an order for free |
| | | movement in a particular zone or |
| | | an order to take a particular |
| | | path (the control entities |
| | | concerned by the path need to be |
| | | specified). Each order must be |
| | | allocated to one or more |
| | | individuals or to a particular |
| | | group of individuals. It is |
| | | also possible to allocate time |
| | | constraints (specified time |
| | | range or date) with an order so |
| | | as to limit its validity. The |
| | | order as created is stored in a |
| | | configuration file. To enable |
| | | it to be taken into account, the |
| | | Mission_Holon must be launched |
| | | in the control entities |
| | | concerned by the zone or the |
| | | path. |
| Edit order | Configurer | Enables a movement order to be |
| | RFID reader | edited. In the event of |
| | | modification, the launched order |
| | | is updated remotely. |
| Delete order | Configurer | On deleting an order, the |
| | | Mission_Holon is removed |
| | | automatically from the control |
| | | entities and is destroyed. |
| Launch order | Configurer | Serves to send a movement order |
| | | (or an access authorization) to |
| | | the control entities concerned. |
| Remove order | Configurer | Enables a movement order (or an |
| | | access authorization) to be |
| | | removed from the control |
| | | entities. |

The following table serves to visualize the various types of action relating to managing groups.

“Management of groups” Table

| | Actor(s) | |
|---|---|---|
| Action | involved | Description |
| Add group | Configurer | Enables a group of individuals |
| | | to be added. For example, a |
| | | group may characterize |
| | | individuals who are to have the |
| | | same behavior and the same |
| | | access authorization. Under |
| | | such circumstances, it is |
| | | simpler to group them together |
| | | and to allocate authorizations |
| | | to the entire group. The groups |
| | | are stored in a configuration |
| | | file. |
| Edit group | Configurer | Enables a group to be edited, |
| | RFID reader | enables a member to be added to |
| | | the group or removed therefrom. |
| | | Modifications to a group are |
| | | sent automatically to all of the |
| | | control entities. |
| Delete a | Configurer | Enables a group to be deleted. |
| group | | Deletion also enables the group |
| | | to be removed from all of the |
| | | control entities. |
| Launch group | Configurer | Enables a group that has been |
| | | created to be launched to all of |
| | | the control entities concerned |
| | | so that it is taken into account |
| | | when managing access |
| | | authorizations. |
| Remove group | Configurer | Enables a group to be removed |
| | | from the control entities. |

The table below serves to visualize the various types of action relating to managing incompatibilities.

“Management of incompatibilities” Table

| | Actor(s) | |
|---|---|---|
| Action | involved | Description |
| Add | Configurer | Enables an incompatibility to |
| incompatibility | | be added. An incompatibility |
| | | may be individual-individual, |
| | | individual-object, group- |
| | | individual (between each of the |
| | | members of the group and one |
| | | individual in particular), |
| | | group-object (between each of |
| | | the members of the group and |
| | | one object in particular), |
| | | group-group (between each of |
| | | the members of the first group |
| | | and each of the members of the |
| | | second group). An |
| | | incompatibility may have two |
| | | degrees of danger: high or low. |
| | | Incompatibilities are stored in |
| | | a configuration file. |
| Edit | Configurer | Enables an incompatibility to |
| incompatibility | RFID | be edited, enables a member to |
| | reader | be added thereto or removed |
| | | therefrom. Modifications to an |
| | | incompatibility are sent |
| | | automatically to all of the |
| | | control entities. |
| Delete | Configurer | Enables an incompatibility to |
| incompatibility | | be deleted. Deletion also |
| | | enables the incompatibility to |
| | | be removed from all of the |
| | | control entities. |
| Launch | Configurer | Enables an incompatibility that |
| incompatibility | | has been created to be launched |
| | | to all of the control entities |
| | | concerned so that it is taken |
| | | into account in managing access |
| | | authorizations. |
| Remove | Configurer | Enables an incompatibility to |
| incompatibility | | be removed from the control |
| | | entities. |

A main role of the control entity modules consists in managing requests for access authorization via the services made available to the various types of Holon. A control entity interacts continuously with external actors that assisted in collecting the data needed to call on the analytic hierarchy process for decision-taking enabling the decision-taking problem relating to an access request to be solved.

The table below serves to visualize the various types of action relating to a control entity of the control system when applied to a detention center.

“Control entity” Table

| | Actor(s) | |
|---|---|---|
| Action | involved | Description |
| Request access | Individual(s) | Any person moving in the |
| | having an | detention center and seeking |
| | RFID badge | to go through a door needs to |
| | | request access from its |
| | | control entity. Access is |
| | | requested by presenting a |
| | | valid RFID badge. If access |
| | | is accepted, the control |
| | | entity sends its new situation |
| | | to all of the other control |
| | | entities so that they update |
| | | the contents of their rooms. |
| Detect RFID | RFID reader | As soon as a badge is |
| badge | | presented, the identifier of |
| | | the individual is detected by |
| | | the RFID reader and |
| | | information about the |
| | | individual is transmitted to |
| | | the corresponding control |
| | | entity. |
| Send situation | Control | The situation (content of the |
| | entities | rooms) is sent after a change |
| | | in topology (connection/ |
| | | disconnection of a particular |
| | | control entity) or after a |
| | | change in the content of a |
| | | room (entry/exit of an |
| | | individual or of an object). |
| Updating the | Function | Each time a control entity |
| situation | triggered | receives the situation of |
| | internally | another control entity, it |
| | | updates its internal situation |
| | | (internal configuration, state |
| | | of the rooms). |
| Updating and | Observer | A control entity is updated |
| reinitializing | | and reinitialized remotely |
| | | from the Observer module in |
| | | the event of a modification |
| | | to the Door_Holon parameters |
| | | or the room parameters. |
| | | After reinitialization, the |
| | | control entity must maintain |
| | | its latest configuration |
| | | (i.e. recover the information |
| | | about the rooms it separates, |
| | | recover all of the |
| | | Individual_Holons and the |
| | | Mission_Holons that were |
| | | present, etc.). This |
| | | updating is sent by the |
| | | Observer module. |

The action for triggering the control method is that of detecting the RFID badge corresponding to an individual. The detection event serves to synchronize the Individual_I_Holon and the Individual_M_Holon (i.e. the individual). Thereafter, the Individual_I_Holon interacts with the various Mission_Holons existing within the control entity in order to verify whether access is or is not authorized for that person, and with the Door_Holon of the door in order to verify access constraints relating to the destination room (maximum capacity, presence of people in conflict, etc.). The results of these interactions are used by the analytic hierarchy process to respond to the access authorization request. Depending on the response, the control entity issues an order to open or not open the door and sends its decision to the Observer module, and its new situation (content of the rooms) to all of the control entities so that they update the contents of their rooms.

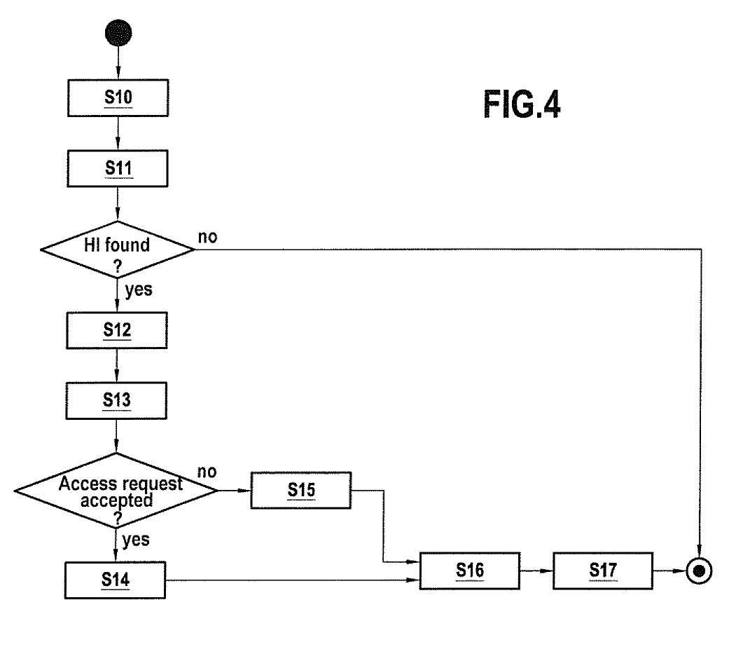

The process of checking an individual (prisoner or warden) in the detention center is shown diagrammatically in FIG. 4. On detecting the RFID badge (S10), the corresponding control entity searches for the corresponding Individual_Holon (S11). If it is found, the Individual_Holon interacts with the corresponding Door_Holon and the various existing Mission_Holons (S12). The analytic hierarchy process is then invoked (S13) in order to determine whether the access request is authorized, in which case the control entity orders opening of the door (S14); or whether it is refused, in which case the control entity orders that the door be kept closed (S15). In either event, the access decision is sent to the Observer module (S16) and the new situation (content of the room) is sent to all of the control entities so that they update the contents of their rooms (S17).

In order to process access authorization requests, each control entity must collect the data needed for executing the analytic hierarchy algorithm. This data is stored in configuration files, which are of two types:
Static data: this comprises data relating to the door, to individuals, to objects, to orders, to groups, and to incompatibilities. Only the Observer module can send updates concerning static data to the various modules of the control entities. Static data is sent as soon as the control entity becomes connected to the network.

Dynamic data: this comprises data relating to the contents of the rooms separated by the door. Specifically, in order to process incompatibilities correctly, each door must have an up-to-date content for the rooms it separates. The contents of the rooms for each door are updated on each access request made for any door and on each entry/exit of an object from any room of the secure zone. This updating is performed by merging the situations (or contents) of the rooms which are sent over the network after each access request from an individual or each entry/exit request for an object.

One of skill in the art will recognize that additional variations may be provided without departing from the scope of the present disclosure.

Throughout the description, including the claims, the term “comprising a” should be understood as being synonymous with “comprising at least one” unless otherwise stated. In addition, any range set forth in the description, including the claims should be understood as including its end value(s) unless otherwise stated. Specific values for described elements should be understood to be within accepted manufacturing or industry tolerances known to one of skill in the art, and any use of the terms “substantially” and/or “approximately” and/or “generally” should be understood to mean falling within such accepted tolerances.

Although the present disclosure herein has been described with reference to particular embodiments, it is to be understood that these embodiments are merely illustrative of the principles and applications of the present disclosure.

It is intended that the specification and examples be considered as exemplary only, with a true scope of the disclosure being indicated by the following claims.

1. A method of controlling the opening of doors giving access to various regulated-access zones in a secure perimeter, the method comprising:
using readers specific to each door of the secure perimeter to obtain an identifier of a person seeking to open a door of the secure perimeter to access a regulated-access zone;
obtaining at least one item of context information relating to the environment of the regulated-access zone into which the person seeks access; and
determining an access decision by a control entity specific to the regulated-access zone into which the person is seeking access, the decision being established on the basis both of the person's identifier and also of the context information.

2. The method according to claim 1, wherein the control entities of the various regulated-access zones in the secure perimeter communicate with one another.

3. The method according to claim 1, wherein the context information is selected from the following information: authorization to access at a determined instant; mode of operation of the regulated-access zone; mode of operation of the door; and presence of constricting elements in the regulated-access zone.

4. The method according to claim 1, wherein the control entity determines the access decision on the basis of a holonic and isoarchical model.

5. The method according to claim 4, wherein the holonic and isoarchical model is constructed from material structures and information structures each of which is associated with the following entities: entities relating to the people to be checked; entities relating to the objects to be checked; entities relating to the doors to be controlled; and entities relating to missions.

6. The method according to claim 4, wherein each entity relating to a person to be checked is constituted by a material structure containing the person proper, and by an information structure containing the identifier of the person, and data relating to tracing movements of the person within the secure perimeter.

7. The method according to claim 4, wherein each entity relating to an object to be checked is constituted by a material structure containing the object proper, and by an information structure containing an identifier of the object, and data relating to the position of the object within the secure perimeter.

8. The method according to claim 4, wherein each entity relating to a door to be controlled is constituted by a material structure containing the door proper, and by an information structure containing data relating to the mode of opening the door.

9. The method according to claim 4, wherein each entity relating to a mission is constituted by a material structure containing one or more regulated-access zones of the secure perimeter, and by an information structure containing access authorizations to said regulated-access zones or a movement order in the secure perimeter.

10. The method according to claim 4, wherein the holonic and isoarchical model from which the access decision is determined is based on an analytic hierarchy process.

11. A system for controlling the opening of doors giving access to various regulated-access zones of a secure perimeter, the system comprising:
a reader configured to read an identifier of a person (I) and associated with each door of the secure perimeter;
a context information obtaining unit configured to obtain at least one item of context information relating to the environment of each regulated-access zone of the secure perimeter; and
control entities specific to each regulated-access zone of the secure perimeter, each of said control entities being suitable for making an access decision on the basis both of an identifier of a person seeking to open a door of the secure perimeter in order to access a regulated-access zone and context information relating to the environment of the regulated-access zone that the person is seeking to access.

12. The system according to claim 11, wherein each control entity of the various regulated-access zones of the secure perimeter is connected to each of the other control entities of the various regulated-access zones of the secure perimeter to permit an exchange of data.

13. The system according to claim 11, wherein the reader comprises a badge reader operating by radio identification.
